(19) United States
(12) Patent Application Publication
(10) Pub. No.: US 2009/0020167 A1
(43) Pub. Date: Jan. 22, 2009

(54) Rotary Actuator Lever with Locking Device

(76) Inventor: David J. Koester, Gladbrook, IA (US)

Correspondence Address: MARSHALL, GERSTEIN & BORUN LLP (FISHER), 233 SOUTH WACKER DRIVE, 6300 SEARS TOWER, CHICAGO, IL, 60606, US

(21) Appl. No.: 11/780,802

(22) Filed: Jul. 20, 2007

(51) Int. Cl. F16K 31/00; F16K 51/00; F16K 99/00

(52) U.S. Cl. 137/315.37; 251/58

(57) ABSTRACT

A fluid control device or a device for coupling a rotary valve actuator to a rotary valve shaft comprises a housing, a lever, a threaded collet, and first and second stops carried by the housing. The lever comprises a cylindrical member containing the threaded collet. During operation, the first and second stops limit the rotation of the lever between first and second positions, thereby limiting rotation of the valve shaft. During assembly, the device further comprises a third stop that is removably carried by the housing. The third stop engages the lever in the first position simultaneously with the first stop, for example, thereby locking the lever against rotation. With the lever locked, a technician may apply generally any amount of torque to a draw nut disposed on the collet to tighten and/or loosen the collet onto the rotary valve shaft without rotating the lever.

### FIELD OF THE INVENTION

The present invention relates to a rotary valve actuator, and more particularly, to a rotary valve actuator having a collet adapted to couple the rotary valve actuator to a rotary valve.

### BACKGROUND

FIGS. 1 and 2 depict one version of a rotary valve actuator 100. The rotary valve actuator 100 generally includes a housing 102 and a drive assembly 104. In FIG. 1, a portion of the housing 102 is removed, thereby exposing the drive assembly 104, which is partially broken away and shown in cross-section, for purposes of description. As will be described in more detail, the drive assembly includes a diaphragm subassembly 110 and a lever 122. The lever 122 is adapted to be coupled to a rotary valve shaft 138 of a rotary valve 101, which is schematically depicted and not to scale.

In general, the diaphragm subassembly 110 is adapted to rotationally displace the lever 122 between a first position (or an “up” position), which is depicted in FIGS. 1 and 2A, for example, and a second position (or a “down” position), which is depicted in FIG. 2B. Accordingly, the lever 122 is adapted for bi-directional rotational displacement within the housing 102.

More specifically, the housing 102 includes a central body portion 106 and a pair of opposing cover plates 108a, 108b. As depicted in FIG. 2, the housing 102 also defines a first threaded aperture 144a and a second threaded aperture 144b. The first threaded aperture 144a contains an up-travel-stop 146 and the second threaded aperture 144b contains a down-travel-stop 148. The up-travel-stop 146 and the down-travel-stop 148 comprise bolts threaded through the respective threaded apertures 144a, 144b. Additionally, as depicted, the up-travel-stop 146 and the down-travel-stop 148 comprise lock-nuts 146a, 148a, respectively. The lock-nuts 146a, 148a are disposed on the bolts to ensure an appropriate amount extends into the housing 102.

Referring back to FIG. 1, the drive assembly 104 includes the aforementioned diaphragm subassembly 110 and a lever subassembly 112. The diaphragm subassembly 110 includes an upper housing 114 containing a diaphragm 116, a diaphragm rod 118, and a pair of springs 119. The diaphragm 116 is operably coupled to the diaphragm rod 118. The springs 119 bias the diaphragm 116, and therefore, the diaphragm rod 118, upward and into the first position depicted in FIGS. 1 and 2A. During operation, a change in pressure within the housing 114 and across the diaphragm 116 displaces the diaphragm rod 118 downward against the bias of the springs 119. The diaphragm rod 118 then, in turn, actuates the drive assembly 104.

The drive assembly 104 includes the lever 122, a collet 124, and a draw nut 125. The lever 122 includes a cylindrical body portion 126, a yoke portion 128 (shown more clearly in FIGS. 2A and 2B), and a stop boss 140 (also shown in FIGS. 2A and 2B). The yoke portion 128 includes a pair of yoke legs 128a (shown in FIG. 1) extending radially away from the body portion 126. The diaphragm rod 118 of the diaphragm subassembly 110 is disposed between the yoke legs 128a and operatively coupled thereto via a nut and bolt assembly 142. The stop boss 140 comprises a projection that also extends radially away from the body portion 126 of the lever 122. The body portion 126 of the lever 122 includes a bore 127 (identified in FIG. 1) which is defined, at least partly, by a generally cylindrical central portion 126a and first and second receiver portions 129a, 129b. The receiver portions 129a, 129b define generally frustoconical inner surfaces of the lever 122.

The collet 124 is a generally rod-shaped member disposed within the bore 127 of the body portion 126 of the lever 122. The collet 124 includes a plurality of collet fingers 134 and a threaded portion 136. The draw nut 125 is threaded onto the threaded portion 136 to secure the collet 124 within the lever 122, as will be described further below. The collet fingers 134 have outer surfaces 134a and inner surfaces 134b. The outer surfaces 134a are shaped and configured to slidably engage with the receiver portion 129a of the lever 122. The inner surfaces 134b are shaped and configured to engage the rotary valve shaft 138, which is disposed between the collet fingers 134 and supported through a mounting yoke 150, as shown in FIG. 1. In FIG. 1, the lever 122 and collet 124 are oriented such that the actuator 100 receives the shaft 138 through the first cover plate 108a, which is depicted on the left-side of the actuator 100 of FIG. 1. However, the lever 122 and collet 124, as well as the mounting yoke 150, are reversible, such that the actuator 100 may be configured to receive the shaft 138 through the second cover plate 108b, which is depicted on the right-side of FIG. 1.

During assembly, the springs 119 of the diaphragm subassembly 110 naturally bias the diaphragm rod 118 upward, thereby placing the lever 122 in the first position depicted in FIG. 2A. Then, to connect the actuator 100 to the valve shaft 138, a technician first positions the valve shaft 138 through the mounting yoke 150 and between the collet fingers 134 of the collet 124. The technician then tightens the draw nut 125 onto the threaded portion 136 of the collet 124 with a wrench, socket, or other tool. The wrench, for example, is used to engage and rotate the draw nut 125 in a clockwise direction, relative to the orientation of FIG. 2A, for example. Referring back to FIG. 1, as the draw nut 125 is tightened onto the collet 124, the collet 124 is drawn to the right, relative to the orientation of FIG. 1. The lever 122, however, abuts the second cover plate 108b and is therefore substantially fixed against axial displacement. Accordingly, the collet 124 displaces within the bore 127 of the lever 122. As the collet 124 displaces through the lever 122, the sliding engagement between the first receiver portion 129a of the lever 122, and the outer surfaces 134a of the collet fingers 134 causes the collet fingers 134 to displace radially inwardly, thereby becoming frictionally wedged between the first receiver portion 129a and the valve shaft 138. Continued tightening of the draw nut 125 further displaces the collet 124 to further wedge the collet fingers 134 and securely couple the valve shaft 138 to the drive assembly 104.

As mentioned above, during use, the diaphragm rod 118 strokes up and down in response to pressure changes within the upper housing 114. This linear stroking of the diaphragm rod 118 is converted into rotational displacement of the lever 122 via the connection between the diaphragm rod 118 and the yoke 128. FIGS. 1 and 2A depict the diaphragm rod 118 positioned at its highest stroke position, i.e., the first or “up” position. So positioned, the stop boss 140 of the lever 122 engages the up-travel-stop 146, as depicted in FIG. 2A, which thereby limits the rotational displacement of the lever 122 in the counterclockwise direction, relative to the orientation of FIG. 2. The up-travel-stop 146 therefore limits the upward stroke of the diaphragm rod 118 and the rotational displacement of the lever 122 to control operation of the adjoining rotary valve 101, and/or to ensure that the springs 119 of the diaphragm subassembly 110 are continuously under compression to control performance of the overall actuator 100.

Alternatively, as the pressure within the upper housing 114 of the diaphragm subassembly 110 changes such as to stroke the diaphragm rod 118 downward and into the housing 102, the lever 122 rotates in the clockwise direction, relative to the orientation of FIGS. 2A and 2B. The down-travel-stop 148 limits the clockwise rotation of the lever 122 by engaging the yoke 128 when the lever 122 reaches the second position, as depicted in FIG. 2B. Specifically, one or both of the yoke legs 128a of the yoke 128 engage the down-travel-stop 148 in the second position. This engagement therefore limits the rotational displacement of the lever 122 and the downward stroke of the diaphragm rod 118 to thereby control operation of the adjoining rotary valve 101, and/or ensure controlled operation of the overall actuator 100.

While the above-described configuration effectively serves to couple such rotary valve shafts 138 to such actuators 100, it is vulnerable to certain inefficiencies. For example, while tightening the draw nut 125 onto the collet 124 in the manner described above, the torque generated by the technician's wrench can displace the lever 122 in the clockwise direction, relative to the orientation of FIG. 2A, against the bias of the springs 119 and out of the first position. Therefore, the technician may experience a bouncing effect, wherein the springs 119 compress under the application of a threshold amount of torque allowing the lever 122 to partially rotate. As the torque is reduced, the springs 119 rotate the lever 122 back into the first position. Accordingly, the amount of torque that may be applied in tightening the draw nut 125 is limited by the threshold force required to compress the springs 119.

Additionally, as mentioned, the collet 124 may be reversed such as to accommodate the mounting yoke 150 and valve shaft 138 through the second cover plate 108b on the right-side of the actuator 100, relative to the orientation of FIG. 1. So configured, as a technician tightens the draw nut 125 onto the collet 124, the torque generated by the wrench would drive the stop boss 140 of the lever 122 into engagement with the up-travel-stop 146. Accordingly, the torque applied in tightening the draw nut 125 is not limited by the springs 119 in this configuration, and therefore the draw nut 125 may be tightened generally any desired amount.

However, upon a technician applying a torque to loosen the draw nut 125 from the collet 124 in this configuration, the torque may rotate the lever 122 against the bias of the springs 119, thereby causing a bouncing effect similar to that in the tightening scenario described above. Therefore, it may become impossible to remove the draw nut 125 from the collet 124 because the amount of torque applied to loosen the draw nut 125 is limited by the compression of the springs 119.

### SUMMARY

The present invention provides a device for coupling a rotary valve actuator to a valve shaft of a rotary valve. One embodiment of the device comprises a housing, a lever, a threaded collet, a first stop, and a second stop. The housing is arranged for connection to the rotary valve adjacent the rotary valve shaft. The lever contains the threaded collet and is disposed within the housing for rotational displacement between a first position and a second position. Additionally, the lever comprises a body portion and a first projection extending from the body portion. The first stop is carried by the housing and adapted to engage the first projection of the lever when the lever is in the first position, to thereby limit the rotational displacement of the lever. The second stop is also carried by the housing and adapted to engage the lever when the lever is in the first position, to thereby limit the rotational displacement of the lever in a second direction and lock the lever against the first stop. With the lever locked in such a manner, a technician may apply a torque to tighten and/or loosen the threaded collet within the lever, to thereby couple or decouple the lever to or from the valve shaft.

In one embodiment, the lever further comprises a second projection extending from the body portion such that the second stop is adapted to engage the second projection to lock the lever in the first position.

In accordance with at least one embodiment, the first projection defines a stop surface adapted to be engaged by the first stop, wherein the stop surface is oriented approximately one hundred and eighty degrees (180°) relative to a lock surface defined by the second projection that is adapted to be engaged by the second stop.

In one alternative embodiment, the first projection defines a stop surface that is oriented approximately ninety degrees (90°) relative to a lock surface of the second projection.

In another embodiment, at least one of the first stop and the second stop comprises a fastener in threaded engagement with the housing. So configured, the fastener may comprise a threaded bolt.

In still another embodiment, at least one of the first stop and the second stop comprises a block removably disposed within the housing.

In a still further embodiment, at least one of the first stop and the second stop comprises a clamp removably secured to the housing and lever.

In yet another alternative embodiment, the device may further comprise a third stop that is adapted to engage the lever when the lever is in the second position. So configured, the third stop may limit the rotational displacement of the lever in the second direction.

### BRIEF DESCRIPTION OF THE DRAWINGS

FIG. 1 is a cross-sectional, partially broken away side view of a known rotary valve actuator coupled to a rotary valve, which is depicted schematically and not to scale;

FIG. 2A is schematic side view of the rotary valve actuator of FIG. 1 with the cover plate removed to depict the lever in a first position and taken from the perspective of line II-II in FIG. 1;

FIG. 2B is schematic side view of the rotary valve actuator of FIG. 1 with the cover plate removed to depict the lever in a second position and taken from the perspective of line II-II in FIG. 1;

FIG. 3 is a schematic side view of a rotary valve actuator incorporating a locking device in accordance with a first embodiment of the present invention;

FIG. 4 is a schematic side view of a rotary valve actuator incorporating a locking device in accordance with a second embodiment of the present invention;

FIG. 5 is a schematic side view of a rotary valve actuator incorporating a locking device in accordance with a third embodiment of the present invention;

FIG. 6 is a schematic side view of a rotary valve actuator incorporating a locking device in accordance with a fourth embodiment of the present invention;

FIG. 7 is a schematic side view of a rotary valve actuator incorporating a locking device in accordance with a fifth embodiment of the present invention; and

FIG. 8 is a schematic side view of a rotary valve actuator incorporating a locking device in accordance with a sixth embodiment of the present invention.

### DETAILED DESCRIPTION

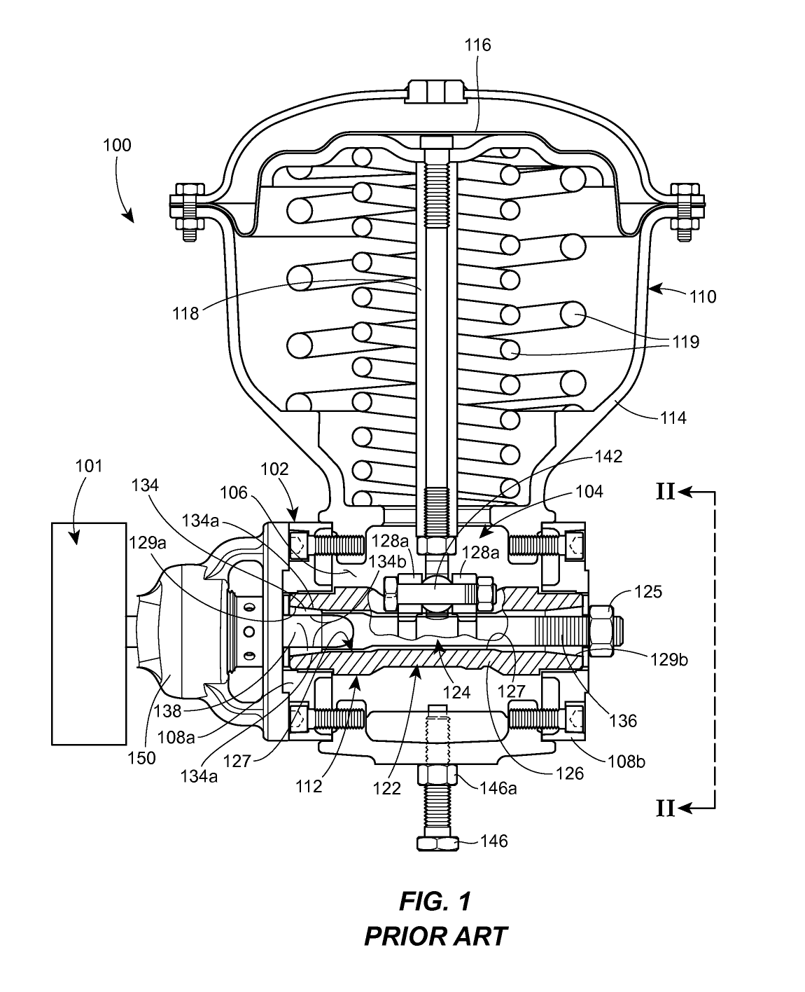

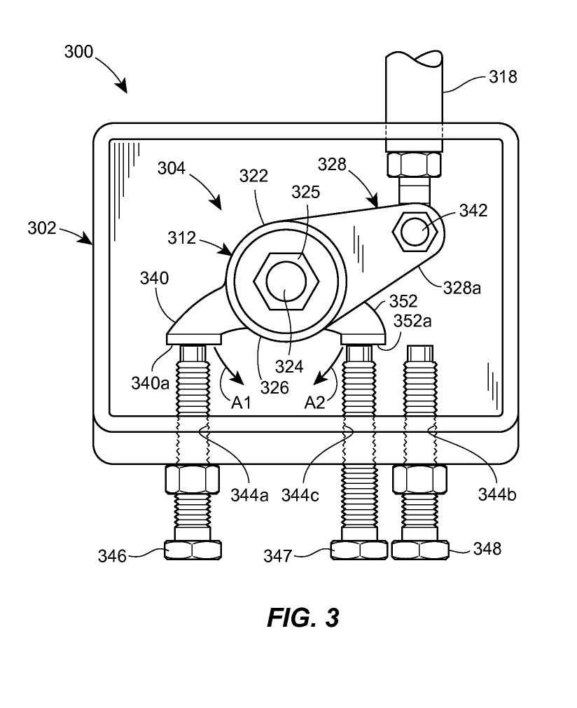

FIG. 3 depicts a side view of a first embodiment of a rotary valve actuator 300 constructed in accordance with the principles of the present invention and adapted to be coupled to the rotary valve 101 depicted in FIG. 1, for example. The rotary valve actuator 300 comprises, in part, a housing 302 and a drive assembly 304. The drive assembly 304 includes a lever subassembly 312 and is adapted to be operatively coupled to a diaphragm rod 318 of a diaphragm subassembly, which may be similar to the diaphragm subassembly 110 described above and depicted in FIG. 1, for example.

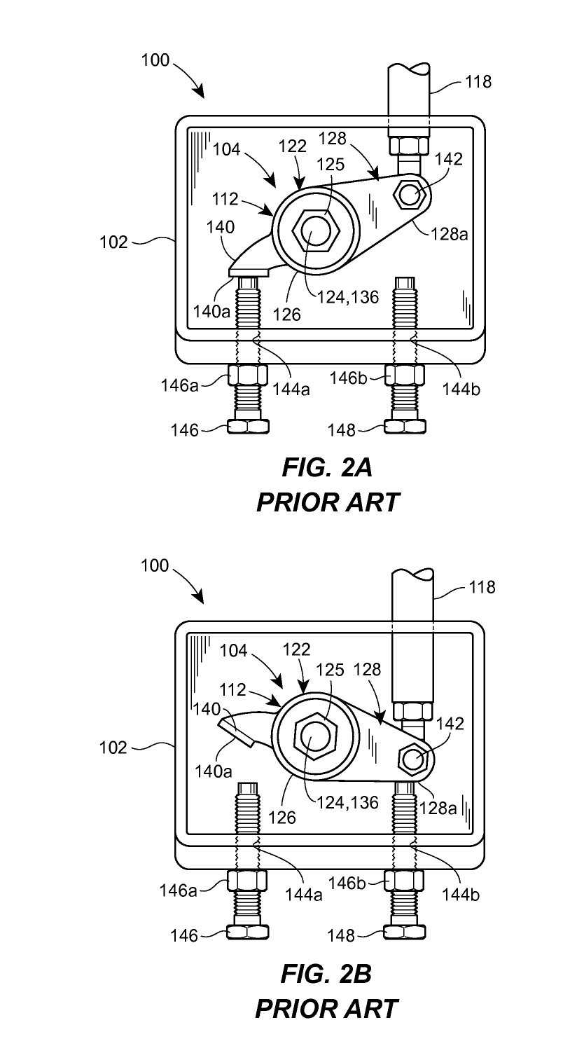

The housing 302 defines a first threaded aperture 344a, a second threaded aperture 344b, and a third threaded aperture 344c. The first threaded aperture 344a retains an up-travel-stop 346. The second threaded aperture 344b retains an up-travel-stop 348. The third threaded aperture 344c retains a lock-stop 347. In the depicted embodiment, the up-travel-stop 346 and the down-travel-stop 348 are identical to the up-travel-stop 146 and the down-travel-stop 148 described above with reference to FIGS. 1, 2A, and 2B. The lock-stop 347, however, merely comprises a bolt threaded through the third threaded aperture 344c.

The lever subassembly 312 of the rotary actuator 300 comprises a lever 322 and a collet 324. The lever 322 comprises a body portion 326, a yoke 328, a stop boss 340, and a lock boss 352. The body portion 326 comprises a generally cylindrical member for retaining a collet 324 in a manner identical to that described above with reference to the collet 124 depicted FIGS. 1, 2A, and 2B. Accordingly, the collet 324 depicted in FIG. 3 also includes a draw nut 325 for tightening the collet 324 into engagement with the valve shaft 138 of the rotary valve 101 of FIG. 1, for example, in a manner identical to that described above with reference to FIGS. 1, 2A, and 2B.

The yoke 328 comprises a pair of yoke legs 328a. The yoke legs 328a comprise projections extending radially away from the body portion 326 of the lever 322. The yoke legs 328a receive a bolt 342 for operatively coupling the lever 322 to the diaphragm rod 318, similar to that described above with reference to FIGS. 1 and 2. The stop boss 340 and the lock boss 352 also comprise projections extending radially away from the body portion 326 of the lever 322. The stop boss 340 defines a stop surface 340a and the lock boss 352 defines a lock surface 352a. The stop surface 340a of the stop boss 340 faces in a first rotational direction of the lever 322, which is indicated by reference arrow A1 in FIG. 3. The lock surface 352a of the lock boss 352 faces in a second rotational direction of the lever 322, which is indicated by reference arrow A2 in FIG. 3. The first rotational direction A1 is opposite to the second rotational direction A2. In the embodiment depicted in FIG. 3, the stop surface 340a on of the stop boss 340 is oriented approximately one-hundred and eighty (180°) from the lock surface 352a of the lock boss 352. In one embodiment, the yoke 328, the stop boss 340, and the lock boss 352 are formed integrally with the lever 312 by a casting process, or some similar manufacturing process. In another embodiment, the yoke 328, the stop boss 340, and the lock boss 352 may be formed separate from the lever 312 and subsequently attached thereto by welding, or some other process.

As depicted in FIG. 3, the up-travel-stop 346 engages the stop surface 340a of the stop boss 340 when the lever 322 is in the first position. Additionally, the lock-stop 347 engages the lock surface 352a of the lock boss 352 when the lever is in the first position. Thus, the up-travel-stop 346 and the lock-stop 347, lock the lever 322 against rotational displacement out of the first position. With the lever 322 locked in this manner, a technician can apply generally any amount of torque to tighten and/or loosen the draw nut 325 without rotationally displacing the lever 322.

During operation of the actuator 300, however, the lock-stop 347 is removed from the third threaded aperture 344c in the housing 302 such that the lever 322 is able to rotate in response to the stroke of the diaphragm rod 318, as described above with reference to the actuator 100 depicted in FIGS. 1 and 2. Alternatively, the lock-stop 347 may be backed out of engagement from the lock boss 352 of the lever 322 an amount sufficient to allow the lever 322 to rotate, but still remaining partially threaded in the third threaded aperture 344c. In another alternative embodiment, the lock-stop 347 and the down-travel-stop 348 may constitute the same threaded bolt. For example, during use of the actuator 300, the bolt 347, 348 may be disposed in the second threaded aperture 344b in the housing 302, thereby acting as the down-travel-stop 348 such that the yoke 328 engages the bolt 347, 348 when the lever 322 rotates into the second position. However, when a technician needs to tighten and/or loosen the draw nut 325, the bolt 347, 348 may be removed from the second threaded aperture 344b and threaded into the third threaded aperture 344c, thereby engaging the lock boss 352 when the lever 322 is in the first position to act as the lock-stop 347.

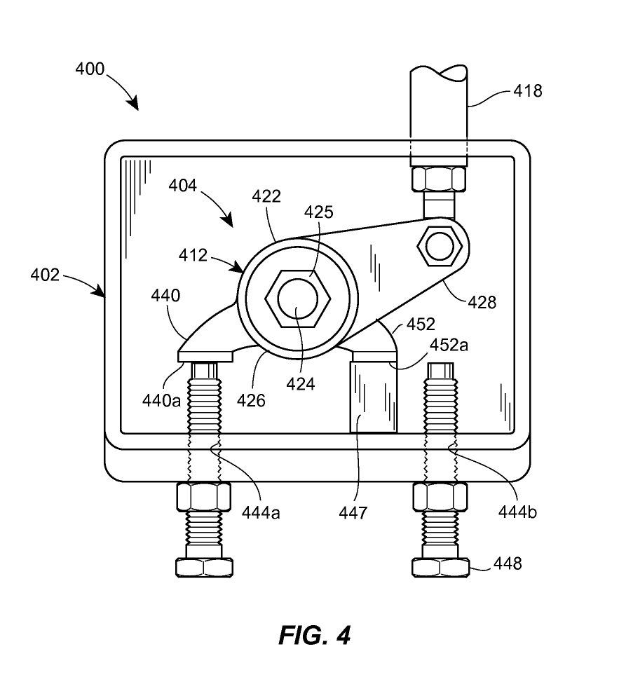

FIG. 4 depicts a side view of an alternative embodiment of a rotary valve actuator 400 constructed in accordance with the principles of the present invention. The rotary valve actuator 400 comprises, in part, a housing 402 and a drive assembly 404. The drive assembly 404 includes a lever subassembly 412 adapted to be operatively coupled to a diaphragm rod 418 of a diaphragm subassembly (not shown) in a manner identical to that described above with reference to FIGS. 1-2. The lever subassembly 412 is identical to the lever subassembly 312 described above with reference to FIG. 3. Specifically, the lever subassembly 412 comprises a lever 422, a collet 424, and a draw nut 425. The lever 412 comprises a body portion 426, a yoke 428, an up-stop-boss 440 defining a stop surface 440a, and a lock-boss 452 defining a lock surface 452a.

The housing 402 is also identical to the housing 302 described above with reference to FIG. 3, with the exception that the housing 402 only defines a first threaded aperture 444a and a second threaded aperture 444b. The first threaded aperture 444a contains an up-travel-stop 446 and the second threaded aperture 444b contains a down-travel-stop 448. The up-travel-stop 446 and the down-travel-stop 448 are identical to the up-travel-stops 146, 346 and the down-travel-stops 148, 348 described above with reference to FIGS. 1-3.

Furthermore, the actuator 400 depicted in FIG. 4 comprises a stop-block 447. The stop-block 447 comprises a block constructed of substantially rigid material such as metal, plastic, wood, etc. The stop-block 447 is removably disposed within the housing 402 and in engagement with the lock surface 452a of the lock-boss 452 when the lever 422 is in the first position, as depicted.

So configured, the up-travel-stop 446 and the stop-block 447 lock the lever 422 against rotational displacement out of the first position. With the lever 422 locked in this manner, a technician can apply generally any amount of torque to tighten and/or loosen the draw nut 425 without rotationally displacing the lever 422.

During operation of the actuator 400, however, the stop-block 447 is removed from the housing 402 such that the lever 422 is able to rotate between the first and second positions with the linear stroke of the diaphragm rod 418, as described above with reference to the actuator 100 depicted in FIGS. 1 and 2.

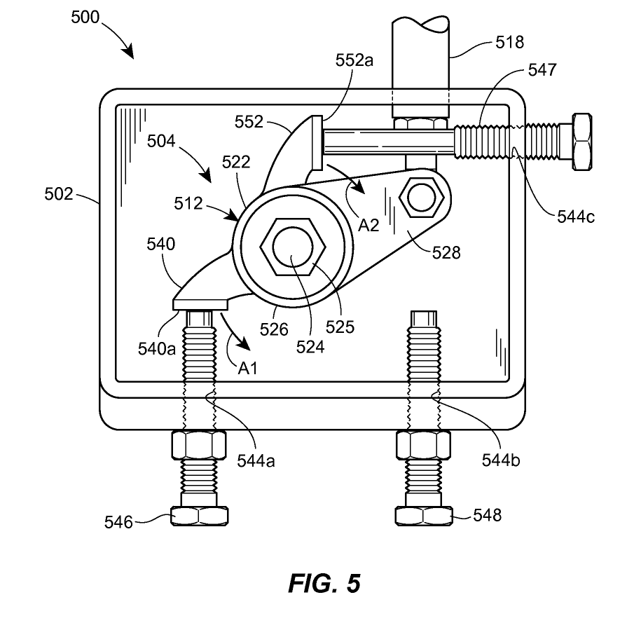

FIG. 5 depicts a side view of yet another embodiment of a rotary valve actuator 500 constructed in accordance with the principles of the present invention. The rotary valve actuator 500 comprises, in part, a housing 502 and a drive assembly 504. The drive assembly 504 includes a lever subassembly 512 adapted to be operatively coupled to a diaphragm rod 518 of a diaphragm subassembly (not shown) in a manner identical to that described above with reference to FIGS. 1-2. The lever subassembly 512 comprises a lever 522, a collet 524, and a draw nut 525. The lever 522 comprises a body portion 526, a yoke 528, an up-stop-boss 540 defining a stop surface 540a, and a lock boss 552 defining a lock surface 552a. A distinction between the lever assembly of FIG. 5 and the lever subassemblies 312, 412 described above with reference to FIGS. 3 and 4 is that the stop surface 540a of the up-stop-boss 540 is disposed approximately ninety degrees (90°) from the lock surface 552a of the lock-boss 552. However, similar to the lever assemblies 312, 412 described above, the stop surface 540a of the stop boss 540 faces in a first rotational direction of the lever 522, which is indicated by arrow A1 in FIG. 5. The lock surface 552a of the lock boss 552 faces in a second rotational direction of the lever 522, which is indicated by the arrow A2 in FIG. 5. The first rotational direction A1 is opposite the second rotational direction A2.

The housing 502 of the embodiment depicted in FIG. 5 is substantially identical to the housing 302, described above with reference to FIG. 3, in that the housing 502 defines a first threaded aperture 544a, a second threaded aperture 544b, and a third threaded aperture 544c. The first and second threaded apertures 544a, 544b are disposed on the bottom of the housing 502, identical to the first and second threaded apertures 344a, 344b of the housing 302 depicted in FIG. 3. The third threaded aperture 544c in the housing of FIG. 5, however, is disposed through the side of the housing 502, relative to the orientation of FIG. 5.

So configured, the first threaded aperture 544a contains an up-travel-stop 546 and the second threaded aperture 544b contains a down-travel-stop 548. This is virtually identical to the actuators 300, 400 described above with reference to FIGS. 3 and 4. The up-travel-stop 546 and the down-travel-stop 548 are identical to the up-travel-stops 146, 346, 446 and the down-travel-stops 148, 348, 448 described above with reference to FIGS. 1-4.

Furthermore, the actuator 500 comprises a lock-stop 547 disposed within the third threaded aperture 544c. The lock-stop 547 comprises a threaded bolt similar to the threaded bolts of the up-travel-stop 546 and the down-travel-stop 548, except that the lock-stop 547 of the depicted embodiment of FIG. 5 is substantially longer and does not include a lock-nut. Nevertheless, the actuator 500 may be designed and constructed differently such that in alternative embodiments, the lock-stop 547 may be equal in length or shorter than either or both of the up-travel-stop 546 and the down-travel-stop 548.

Thus, as depicted, the up-travel-stop 546 engages the stop surface 540a of the stop boss 540 and the lock-stop 547 engages the lock-surface 552a of the lock boss 552 when the lever 522 is in the first position. The up-travel-stop 546 and the lock-stop 547, therefore, lock the lever 522 against rotational displacement out of the first position. With the lever 522 locked in this manner, a technician can apply generally any amount of torque to tighten and/or loosen the draw nut 525 without rotating the lever 522.

During operation of the actuator 500, however, the lock-stop 547 is removed from the housing 502 such that the lever 522 is able to rotate in response to the linear stroke of the diaphragm rod 518, as described above with reference to the actuator 100 depicted in FIGS. 1 and 2. In an alternative embodiment, the lock-stop 547 may simply be backed out of the third threaded aperture 544c an amount sufficient to prevent interference with the lever 522 while the lever 522 rotates.

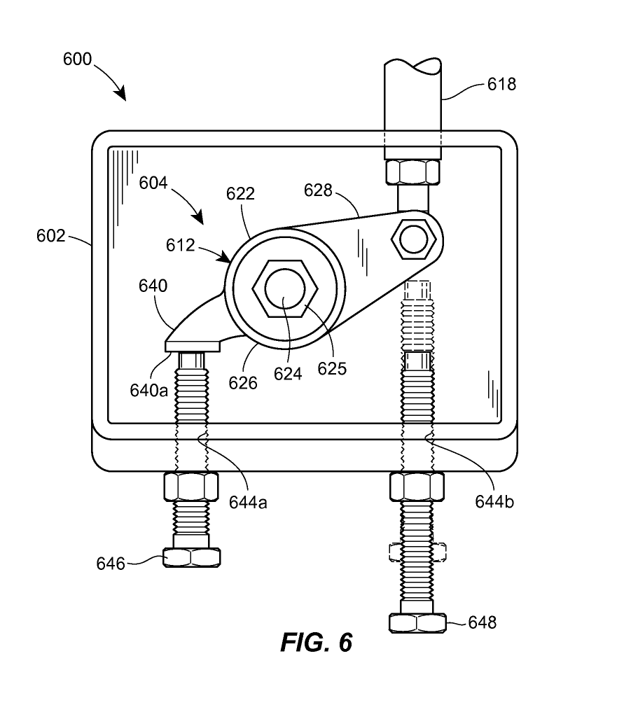

FIG. 6 depicts a side view of yet another embodiment of a rotary valve actuator 600 constructed in accordance with the principles of the present invention. The rotary valve actuator 600 comprises, in part, a housing 602 and a drive assembly 604. The drive assembly 604 includes a lever subassembly 612 adapted to be operatively coupled to a diaphragm rod 618 of a diaphragm subassembly (not shown) in a manner identical to that described above with reference to FIGS. 1-2. The lever subassembly 612 is identical to the lever subassembly 112 described above and depicted in FIGS. 1 and 2. Specifically, the lever subassembly 612 comprises a lever 622, a collet 624, and a draw nut 625. The lever 622 comprises a body portion 626, a yoke 628, and an up-stop-boss 640 defining a stop surface 640a.

The housing 602 is also identical to the housing 102 described above with reference to FIGS. 1 and 2, in that the housing 602 defines a first threaded aperture 644a and a second threaded aperture 644b. The first threaded aperture 644a retains an up-travel-stop 646 and the second threaded aperture retains a down-travel-stop 648. The up-travel-stop 646 and the down-travel-stop 648 comprise threaded bolts. The up-travel-stop 646 is identical to the up-travel-stops 146, 346, 446, 546 described above with reference to FIGS. 1-5. The down-travel-stop 648 is similar to the down-travel-stops 148, 348, 448, 548 described above with reference to FIGS. 1-5 with the exception that the down-travel-stop 648 of the embodiment depicted in FIG. 6 includes a substantially longer bolt.

Therefore, as is depicted in phantom in FIG. 6, the down-travel-stop 648 can be threaded into the housing 602 such that it engages the yoke 628 of the lever 622 while the lever 622 is in the first position. So configured, the down-travel-stop 648 locks the stop boss 640 of the lever 622 in engagement with the up-travel-stop 646 to prevent rotation of the lever 622 out of the first position. With the lever 622 locked in this manner, a technician can apply generally any amount of torque to tighten and/or loosen the draw nut 625 without displacing the lever 622.

During operation of the actuator 600, however, the down-travel-stop 648 is backed away from the yoke 628 of the lever 622 and into the position illustrated with solid lines if FIG. 6. With the down-travel-stop 648 so positioned, the lever 622 is able to rotate between the first and second positions with the linear stroke of the diaphragm rod 618 in manner identical to that described above with reference to the actuator 100 depicted in FIGS. 1 and 2.

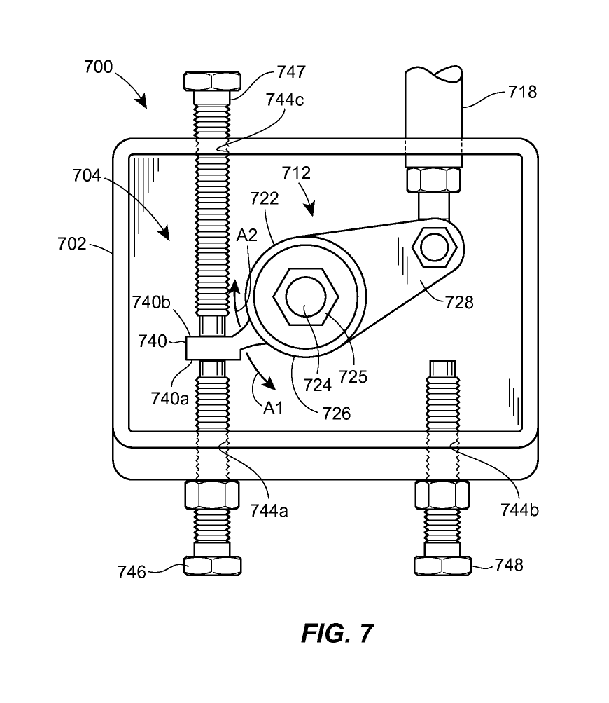

FIG. 7 depicts a side view of yet another embodiment of a rotary valve actuator 700 constructed in accordance with the principles of the present invention. The rotary valve actuator 700 comprises, in part, a housing 702 and a drive assembly 704. The drive assembly 704 includes a lever subassembly 712 adapted to be operatively coupled to a diaphragm rod 718 of a diaphragm subassembly (not shown) in a manner identical to that described above with reference to FIGS. 1-2. The lever subassembly 712 is identical to the lever subassembly 112 described above and depicted in FIGS. 1 and 2. Specifically, the lever subassembly 712 comprises a lever 722, a collet 724, and a draw nut 725. The lever 722 comprises a body portion 726, a yoke 728, and a stop boss 740 defining a stop surface 740a. Additionally, the stop boss 740 further defines a lock surface 740b that is disposed opposite the stop surface 740a. More specifically, the stop surface 740a faces in a first rotational direction of the lever 722, which is indicated by arrow A1 in FIG. 7. The lock surface 740b faces in a second rotational direction of the lever 722, which is indicated by the arrow A2 in FIG. 7. The first rotational direction A1 is opposite the second rotational direction A2.

The housing 702 is substantially identical to the housing 502 described above with reference to FIG. 5, in that the housing 702 defines first, second, and third threaded apertures 744a, 744b, 744c. While the first and second threaded apertures 744a, 744b are oriented identical to the first and second threaded apertures 544a, 544b of the actuator depicted in FIG. 5, the third threaded aperture 744c is disposed on top of the housing 702, relative to the orientation of FIG. 7.

Accordingly, as depicted, the first threaded aperture 744a contains an up-travel-stop 746 and the second threaded aperture 744b contains a down-travel-stop 748. In the disclosed embodiment, the up-travel-stop 746 and the down-travel-stop 748 are identical to the up-travel-stops 146, 346, 446, 546 and down-travel-stops 148, 348, 448, and 548 described above with reference to FIGS. 1-5. Moreover, the third threaded aperture 744c contains a lock-stop 747. In the disclosed embodiment, the lock-stop 747 comprises a threaded bolt, but no lock-nut. In the embodiment depicted in FIG. 7, the threaded bolt of the lock-stop 747 is longer than the up-travel-stop 746 and the down-travel-stop 748. However, in alternative embodiments, the lock-stop 747 may be equal in length or shorter than either or both of the up-travel-stop 746 and the down-travel-stop 748, depending on the actual configuration of the housing 702, and the lever 712.

As depicted in FIG. 7, the up-travel-stop 746 engages the stop surface 740a of the stop boss 740 of the lever 722 when the lever 722 is in the first position. Additionally, the lock-stop 747 engages the lock surface 740b of the stop boss 740 of the lever 722 when the lever 722 is in the first position. Thus, the up-travel-stop 746 and the lock-stop 747 lock the lever 722 against rotation out of the first position. With the lever 722 locked in this manner, a technician can apply generally any amount of torque to tighten and/or loosen the draw nut 725 without displacing the lever 722.

During operation of the actuator 700, however, the lock-stop 747 is removed from the third threaded aperture 744c such that the lever 722 is able to rotate in response to the linear stroke of the diaphragm rod 718 in a manner identical to that described above with reference to the actuator 100 depicted in FIGS. 1 and 2. Alternatively, instead of wholly removing the lock-stop 747 from the housing 702, the lock-stop 747 may merely be backed out of the third threaded aperture 744c such that it does not interfere with the rotation of the lever 722 during operation of the actuator 700.

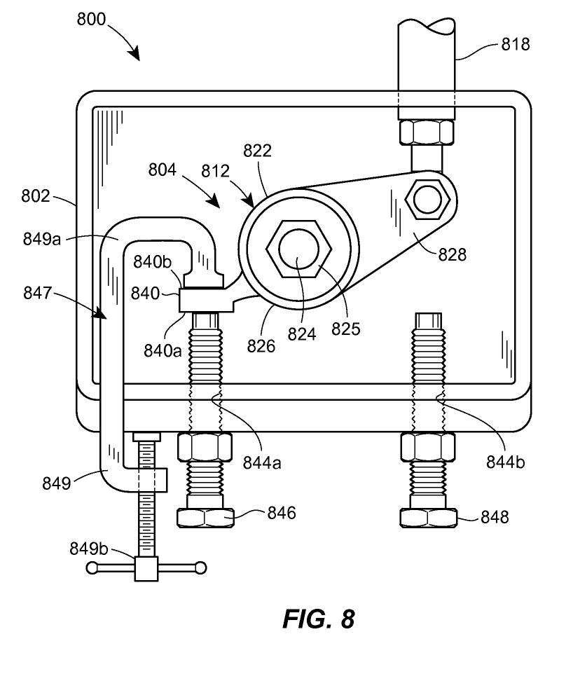

FIG. 8 depicts a side view of yet another embodiment of a rotary valve actuator 800 constructed in accordance with the principles of the present invention. The rotary valve actuator 800 comprises, in part, a housing 802 and a drive assembly 804. The drive assembly 804 includes a lever subassembly 812 adapted to be operatively coupled to a diaphragm rod 818 of a diaphragm subassembly (not shown) in a manner identical to that described above with reference to FIGS. 1-2. The lever subassembly 812 is identical to the lever subassembly 712 described immediately above with reference to FIG. 7. Specifically, the lever subassembly 812 comprises a lever 822, a collet 824, and a draw nut 825. The lever 822 comprises a body portion 826, a yoke 828, and an up-stop-boss 840 defining a stop surface 840a and a lock surface 840b.

The housing 802 is substantially identical to the housings 102, 402, and 602 described above with reference to FIGS. 1, 2, 4, and 6, in that the housing 802 defines a first threaded aperture 844a and a second threaded aperture 844b retaining an up-travel-stop 846 and a down-travel-stop 848, respectively. In the disclosed embodiment, the up-travel-stop 846 and the down-travel-stop 848 are identical to the up-travel-stops 146, 346, 446, 546, 746 and the down-travel-stops 148, 348, 448, 548, 748 described above with reference to FIGS. 1-5 and 7.

Additionally, as depicted in FIG. 8, the actuator 800 comprises a lock-stop 847, which includes a c-clamp 849. The c-clamp 849 comprises a generally known commercial c-clamp having a c-shaped body 849a and a threaded shaft 849b.

As depicted in FIG. 8, the up-travel-stop 846 engages the stop surface 840a of the stop boss 840 of the lever 822 when the lever 822 is in the first position. Additionally, the c-clamp 849 is configured such that the body 849a engages the lock surface 840b of the stop boss 840, while the threaded shafts 849b engages the housing 802 at a location proximate to the first threaded aperture 844a and the up-travel-stop 846, when the lever 822 is in the first position. Thus, the up-travel-stop 846 and the lock-stop 847 lock the lever 822 against rotation out of the first position. With the lever 822 locked in this manner, a technician can apply generally any amount of torque to tighten and/or loosen the draw nut 825 without displacing the lever 822.

During operation of the actuator 800, however, the lock-stop 847 is disengaged from the lock surface 840b of the stop boss 840 and the housing 802. So configured, the lever 822 is able to rotate in response to the linear stroke of the diaphragm rod 818 in a manner identical to that described above with reference to the actuator 100 depicted in FIGS. 1 and 2. In the disclosed embodiment, a technician disengages the lock-stop 847 by rotating the threaded shaft 849b relative to the c-shaped body 849a, thereby first disengaging the threaded shaft 849b from the housing 802 and allowing the c-shaped body 849a to be disengaged from the stop boss 840.

While the description has thus far described and depicted various devices for locking a lever of a rotary valve actuator for tightening and/or loosening a collet, the present invention is not limited by any of the examples provided herein. Rather, the present invention is intended to include the subject matter disclosed herein, as well as any and all other subject matter that falls within the spirit and scope of the following claims.

For example, while the up-travel-stops 246-846 and the down-travel-stops 248-848 have been disclosed herein as comprising threaded bolts, alternative embodiments of the invention may comprise generally any device operable to serve the intended purpose. Moreover, while the lock-stops 247-847 have been disclosed as comprising either threaded bolts, blocks, or clamps, alternative embodiments of the present invention may include lock-stops 247-847 comprising generally any device capable of locking the levers 222-822. For example, with reference to the embodiment depicted in FIG. 4, the stop-block 447 need not actually comprise a block, but rather, may comprise a ball-bearing, or any other device capable of providing the support between the lock boss 452 and the housing 402. Additionally, with reference to the embodiments depicted in FIGS. 3 and 5-7, the lock-stops 347 and 547-747 need not actually comprise threaded bolts, but rather may comprise sliding pins, sliding pins with detent mechanisms, or any other device capable of providing the intended function and result.

Furthermore, while the present disclosure has described actuators 200-800 having lever subassemblies 212-812 adapted to be locked in a first position, which is defined as the “up” position, alternative embodiments of the actuators 200-800 may be adapted to be locked in the second position, which may be defined as the “down” position. Finally, while the specification has defined the first position as the “up” position of the actuators 200-800 and the second position as the “down” position, an alternative embodiment of the actuators 200-800 may define the first position as the “down position” and the second position as the “up” position. Specifically, any recitation of first and second position in the attached claims are not to be limited by the description, but rather, are to be defined as including any two positions, which may even include the same position.

Finally, while the specification has described the present invention in the context of the actuator 100 depicted in FIG. 1, the actuator 100 is merely an example of one such actuator that may be adapted for use with the present invention. The present invention is not limited to the actuator disclosed, but rather, may be adapted to any such actuator or any other device, as defined by the claims.

What is claimed:

1. A device for coupling a rotary valve actuator to a valve shaft of a rotary valve, the device comprising:
a housing arranged for connection to the rotary valve adjacent the rotary valve shaft;
a lever disposed within the housing for rotational displacement between a first position and a second position, the lever arranged to be removably coupled to the valve shaft of the rotary valve; and
at least one stop carried by the housing and engaging the lever when the lever is in the first position to lock the lever in the first position and prevent the lever from rotating toward the second position.

2. The device of claim 1, wherein the lever further comprises a first projection engaged by the at least one stop when in the first position.

3. The device of claim 1, wherein the at least one stop comprises a first stop and a second stop engaging the lever when the lever is in the first position.

4. The device of claim 3, wherein the lever further comprises a first projection and a second projection, the first projection engaged by the first stop and the second projection engaged by the second stop when the lever is in the first position.

5. The device of claim 4, wherein the first projection defines a stop surface that is oriented approximately one hundred and eighty degrees (180°) relative to lock surface defined by the second projection.

6. The device of claim 4, wherein the first projection defines a stop surface that is oriented approximately ninety degrees (90°) relative to a lock surface on the second projection.

7. The device of claim 1, wherein the at least one stop comprises a fastener in threaded engagement with the housing.

8. The device of claim 1, wherein the at least one stop comprises a block removably disposed within the housing.

9. The device of claim 1, wherein the at least one stop comprises a clamp.

10. The device of claim 1, wherein the at least one stop is removably attachable to the housing.

11. The device of claim 3, further comprising a third stop engaging the lever when the lever is in the second position.

12. The device of claim 1, further comprising a collet carried by the lever and adapted to operatively couple the lever to the rotary valve shaft.

13. A device for coupling a rotary valve actuator to a valve shaft of a rotary valve, the device comprising:
a housing arranged for connection to the rotary valve adjacent the rotary valve shaft;
a lever disposed within the housing for rotational displacement between a first position and a second position, the lever comprising a body portion and a first projection extending from the body portion;
a first stop disposed in engagement with the first projection of the lever and the housing when the lever is in the first position, the first stop adapted to limit the rotational displacement of the lever in a first direction; and
a second stop disposed in engagement with the lever and the housing when the lever is in the first position, the second stop adapted to limit the rotational displacement of the lever in a second direction that is opposite the first direction.

14. The device of claim 13, wherein the second stop is in engagement with the first projection when the lever is in the first position.

15. The device of claim 13, wherein the lever further comprises a second projection extending from the body portion and the second stop is in engagement with the second projection when the lever is in the first position.

16. The device of claim 15, wherein the first projection defines a stop surface that is oriented approximately one hundred and eighty degrees (180°) relative to a lock surface defined by the second projection.

17. The device of claim 15, wherein the first projection defines a stop surface that is oriented approximately ninety degrees (90°) relative to a lock surface of the second projection.

18. The device of claim 13, wherein at least one of the first stop and the second stop comprises a fastener in threaded engagement with the housing.

19. The device of claim 18, wherein the fastener comprises a threaded bolt.

20. The device of claim 13, wherein at least one of the first stop and the second stop comprises a block removably disposed within the housing.

21. The device of claim 13, wherein at least one of the first stop and the second stop comprises a clamp.

22. The device of claim 13, wherein at least one of the first stop and the second stop are removably attachable to the housing.

23. The device of claim 13, further comprising a third stop disposed in engagement with the lever and the housing when the lever is in the second position, the third stop adapted to limit the rotational displacement of the lever in the second direction.

24. The device of claim 13, wherein the lever further comprises a yoke extending from the body portion, the yoke adapted to operatively connect the lever to an actuator rod, and wherein the second stop is disposed in engagement with the yoke when the lever is in the first position to limit rotation of the lever in the second direction.

25. The device of claim 13, further comprising a collet carried by the lever and adapted to operatively couple the lever to the rotary valve shaft.

26. A device for coupling a rotary valve actuator to a valve shaft of a rotary valve, the device comprising:
a housing arranged for connection to the rotary valve adjacent the rotary valve shaft;
a lever disposed within the housing and adapted for rotational displacement in a first direction into a first position and a second direction into a second position, the lever comprising a first surface facing the first direction and a second surface facing the second direction, the first and second surfaces extending radially away from the lever;
a first stop carried by the housing and contacting the first surface when the lever is in the first position; and
a second stop carried by the housing and contacting the second surface when the lever is in the first position.

27. The device of claim 26, wherein the lever comprises at least one projection carrying the first and second surfaces.

28. The device of claim 26, wherein the lever comprises a first projection carrying the first surface and a second projection carrying the second surface.

29. The device of claim 28, wherein the first surface is oriented approximately one hundred and eighty degrees (180°) relative to the second surface.

30. The device of claim 28, wherein the first surface is oriented approximately ninety degrees (90°) relative to the second surface.

31. The device of claim 26, wherein at least one of the first stop and the second stop comprises a fastener in threaded engagement with the housing.

32. The device of claim 31, wherein the fastener comprises a threaded bolt.

33. The device of claim 31, wherein at least one of the first stop and the second stop comprises a block removably disposed within the housing.

34. The device of claim 26, wherein at least one of the first stop and the second stop comprises a clamp.

35. The device of claim 26, wherein at least one of the first stop and the second stop are removably attachable to the housing.

36. The device of claim 26, further comprising a third stop carried by the housing and engaging the lever when the lever is in the second position.

37. The device of claim 27, wherein the lever further comprises a yoke adapted to operatively connect the lever to an actuator rod, and wherein the second surface is carried by the yoke.

38. The device of claim 26, further comprising a collet carried by the lever and adapted to operatively couple the lever to the rotary valve shaft.

39. A fluid control device comprising:
a rotary valve having a control element and a valve shaft;
a housing arranged for connection to the rotary valve adjacent the rotary valve shaft;
a lever disposed within the housing and coupled to the valve shaft of the rotary valve, the lever rotatable between a first position and a second position relative to the housing for rotating the control element;
a first stop engaging the lever and the housing when the lever is in the first position, the first stop adapted to limit the rotational displacement of the lever in a first direction; and
a second stop engaging the lever and the housing when the lever is in the first position, the second stop adapted to limit the rotational displacement of the lever in a second direction that is opposite the first direction.

40. The device of claim 39, wherein the lever comprises a first radial projection and the second stop engages the first radial projection when the lever is in the first position.

41. The device of claim 40, wherein the lever further comprises a second radial projection and the second stop engages the second radial projection when the lever is in the first position.

42. The device of claim 41, wherein the first radial projection carries a stop surface that is oriented approximately one hundred and eighty degrees (180°) relative to a lock surface carried by the second radial projection.

43. The device of claim 41, wherein the first radial projection carries a stop surface that is oriented approximately ninety degrees (90°) relative to a lock surface carried by the second radial projection.

44. The device of claim 39, wherein at least one of the first stop and the second stop comprises a fastener in threaded engagement with the housing.

45. The device of claim 39, wherein at least one of the first stop and the second stop are removably attachable to the housing.

46. The device of claim 39, further comprising a third stop engaging the lever and the housing when the lever is in the second position, the third stop adapted to limit the rotational displacement of the lever in the second direction.

47. The device of claim 39, further comprising a collet carried between the lever and the valve shaft for coupling the lever to the valve shaft.
